(19) United States
(12) Patent Application Publication
(10) Pub. No.: US 2023/0097284 A1
(43) Pub. Date: Mar. 30, 2023

(54) ROBOTIC HARVESTING SYSTEMS AND METHODS

(71) Applicant: APPHARVEST TECHNOLOGY, INC., Morehead, KY (US)

(72) Inventors: Ryan R. Knopf, Melrose, MA (US); Jason A. Chrisos, Somerville, MA (US); Michele Pratusevich, Somerville, MA (US); Ryan Wasserman, Wobum, MA (US); Joshua Aaron Lessing, Cambridge, MA (US)

(21) Appl. No.: 17/759,162

(22) PCT Filed: Jan. 20, 2021
(86) PCT No.: PCT/US2021/014201

§ 371 Date: Jul. 20, 2022

Related U.S. Application Data
(60) Provisional application No. 62/963,280, filed on Jan. 20, 2020.

(51) Int. Cl. A01D 46/30

(52) U.S. Cl. CPC A01D 46/30

(57) ABSTRACT

Robotic systems and methods for harvesting agricultural produce along multiple rows crops are disclosed. A mobile platform may include a robotic arm having a gripping tool and repositionable catch for collecting harvested target objects. A vision system may facilitate the identification of target objects and an associated controller may coordinate the various operational functions.

### TECHNICAL FIELD

According to one or more aspects, systems and methods for robotic harvesting of agricultural produce are disclosed.

### BACKGROUND

With the advent of hydroponic farming, vertical farming, and urban farming, a new wave of technology has been infused into food production. Some of these technologies include automated farming tools for irrigation and other crop care processes. However, automation of agricultural produce harvesting poses significant challenges.

### SUMMARY

In accordance with one or more aspects, robotic harvesting systems are disclosed. A system may include a mobile platform, a manipulator arm mounted on the mobile platform and including a gripper tool, a collection tray, and a controller. The controller may be configured to position the mobile platform at a first lateral position along a first row of crops, position the manipulator arm at a first operational height, the first lateral position and the first operational height defining a first working area, survey the first working area to identify target objects of agricultural produce for harvesting, and actuate the gripper tool in response to identifying target objects of agricultural produce within the first working area to harvest them.

In some aspects, the controller may be further configured to position the manipulator arm at second and subsequent operational heights. The controller may be further configured to position the mobile platform at second and subsequent lateral positions along the first row of crops. The controller may be further configured to reposition the mobile platform at the first lateral position after the second lateral position along the first row of crops.

In some aspects, the system may further comprise a vision system in cooperation with the controller to identify the target objects of agricultural produce within the first working area. The vision system may comprise one or more of: a color imaging camera, a 3-D depth imaging camera, a graphical processor, and a supplemental light source.

In some aspects, the mobile platform is compatible with equipment guide rails.

In some aspects, the system may further comprise a tray lift in communication with the controller and configured to position the collection tray at a predetermined drop height relative to the gripper tool at each operational height. This drop height determines the maximum distance that a harvested fruit will fall freely before coming into contact with the tray and other previously collected fruits. It is desirable to minimize or control this drop height such that it never exceeds a maximum determined limit for a particular size and weight of fruit to avoid the possibility of damage to the fruit during collection. The controller may be further configured to operate the tray lift and the manipulator arm in unison across operational heights to maintain the predetermined drop height at all points in operation. In at least some aspects, the system may further comprise a plurality of interchangeable collection trays in association with the tray lift, wherein the controller is further configured to periodically replace the collection tray. In some aspects, the collection tray may comprise a sensor. The controller may be further configured to validate delivery of target objects to the collection tray based on input from the sensor.

In some aspects, the target object of agricultural produce may comprise a tomato, a cucumber, a pepper or a strawberry.

In accordance with one or more aspects, methods of harvesting agricultural produce are disclosed. A method may comprise use of the robotic harvesting systems disclosed herein.

In some aspects, the method may further comprise repositioning the robotic harvesting system at a second side of the first row of crops. The method may further comprise repositioning the robotic harvesting system at a first side of a second row of crops.

In some aspects, the method may further comprise preselecting at least one parameter for the identification of target objects within the working area. The at least one parameter may pertain to color, size and/or shape. In some aspects the at least one parameter may relate to accessibility, e.g. obstacle clearance or optimal approach angle. In some aspects, the method may further comprise establishing the predetermined drop height based on at least one property of the target object of agricultural produce. The method may further comprise establishing the various lateral positions and associated operational heights. The method may further comprise delivering a single collection tray or stack of multiple collection trays to a downstream supply chain.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the below detailed description of the disclosed subject matter when considered in connection with the following drawings, in which like reference numerals identify like elements.

FIG. 1 presents an overview schematic of a robotic agricultural product collection system, according to one or more embodiments.

FIG. 2 presents an expanded view of the robotic agricultural product collection system shown in FIG. 1.

FIG. 3 presents a computational system map for a robotic agricultural product collection system, according to one or more embodiments.

FIG. 4 is a flow diagram of an operational method for harvesting agricultural products using a robotic collection system, according to one or more embodiments.

FIG. 5 is a flow diagram of a harvesting cycle using a robotic collection system, according to one or more embodiments.

FIG. 6 shows a vertical agricultural product lift, according to one or more embodiments.

FIG. 7 is a flow diagram of a vertical positioning adjustment routine for an agricultural product lift, according to one or more embodiments.

FIGS. 8A-8C depict a method of vertically adjusting the position of an agricultural product lift, according to one or more embodiments. FIG. 8A shows a ready state. FIG. 8B shows the vertical adjustment of a grasper tool. FIG. 8C shows the vertical adjustment of the agricultural product lift.

FIG. 9 presents a schematic of a vertical arrangement of agricultural product trays adjacent to a related platform, according to one or more embodiments.

FIG. 10 shows an overall view of an optical subsystem of a robotic agricultural product collection system, according to one or more embodiments.

FIG. 11 depicts a mobility platform and controller for a robotic agricultural product collection system, according to one or more embodiments.

FIG. 12 depicts a vertically adjustable robotic arm and a grasper tool, according to one or more embodiments.

FIG. 13 presents an overall view of a button-style control interface, according to one or more embodiments.

FIGS. 14A-14C depict a method of harvesting agricultural products using a robotic collection system, according to one or more embodiments. FIG. 14A shows a robotic agricultural product collection system passing along a row in one direction. FIG. 14B shows the robotic agricultural product collection system being turned around and directed along the row in a different direction. FIG. 14C shows the robotic agricultural product collection system being placed into an adjacent row.

### DETAILED DESCRIPTION

In accordance with one or more embodiments, systems and methods for harvesting agricultural produce are disclosed. In some embodiments, robotic systems and methods for harvesting agricultural produce are disclosed. In at least some embodiments, agricultural produce may be harvested autonomously or semi-autonomously.

In accordance with one or more embodiments, a robotic harvesting system may automatically identify, navigate to, harvest, and deliver ripe agricultural produce directly from a growing environment to a supply chain. As the availability of capable farm hands diminishes throughout the world, farmers will increasingly require the use of technology to complete the daily work tasks of a farm with fewer workers. Beneficially, the disclosed robotic harvesting systems and methods may enable a single worker to simultaneously harvest ripe agricultural produce across multiple crop rows, patches, or fields.

In accordance with one or more embodiments, a robotic harvesting system may generally include various elements and/or subsystems as described further herein including but not limited to a multiple degree-of-freedom robotic arm, a computer vision system, a grasping tool, a repositionable catch or collection zone, a motorized mobile platform, and a main harvesting control unit.

In operation, a robotic harvesting system may be positioned at a starting point within a crop row and activated by an operator's command. A harvesting method may include an operating process which incrementally harvests one side of one row of crop automatically. The operating process may generally contain three cyclical steps which are repeated until no additional agricultural produce can be harvested or the end of the row is reached. The first step moves the robot laterally to a new location along the length of the row where harvesting work has not yet been done. The second step moves the manipulator arm, vision system, and catch to various heights above the floor at which to work. The second step additionally may include a parameterizable clearance distance which may be selected to always maintain a maximum drop height from which the target object is released to avoid damage from impact with the catch. The third step executes one or more “harvesting cycles” which ultimately harvest a collection of target objects deemed to meet various requirements for size, ripeness, and other characteristics by the vision system. The third step additionally includes several described responses which may preemptively terminate the attempt to harvest a target object in order to avoid an imminent collision, respond to a detected collision, or avoid damaging the plant being manipulated.

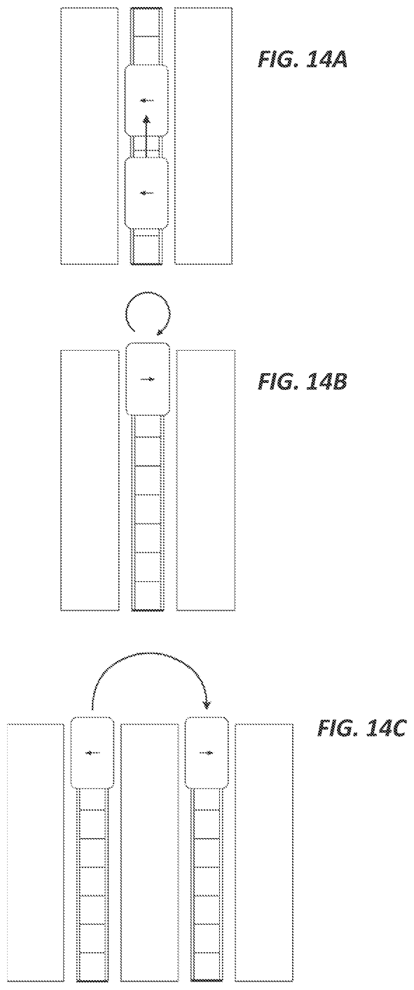

In accordance with one or more embodiments, multiple crop rows on both sides may be harvested. In some embodiments, an operator may intervene periodically in order to position the mobile robot in a new orientation or crop row before each execution of the previously described method. In at least some embodiments, the system may be repositioned by a human operator according to FIGS. 14A-C.

In accordance with one or more embodiments, a robotic harvesting system may generally include various components used in combination to achieve the desired operational processes. In some embodiments, the system may include a mobility platform, a robotic arm including a grasping tool, and a repositionable collection tray. A computer vision system may facilitate the identification of target objects of agricultural produce for harvesting. A controller may coordinate various functions of each subsystem to accomplish the overall operating process for harvesting agricultural produce.

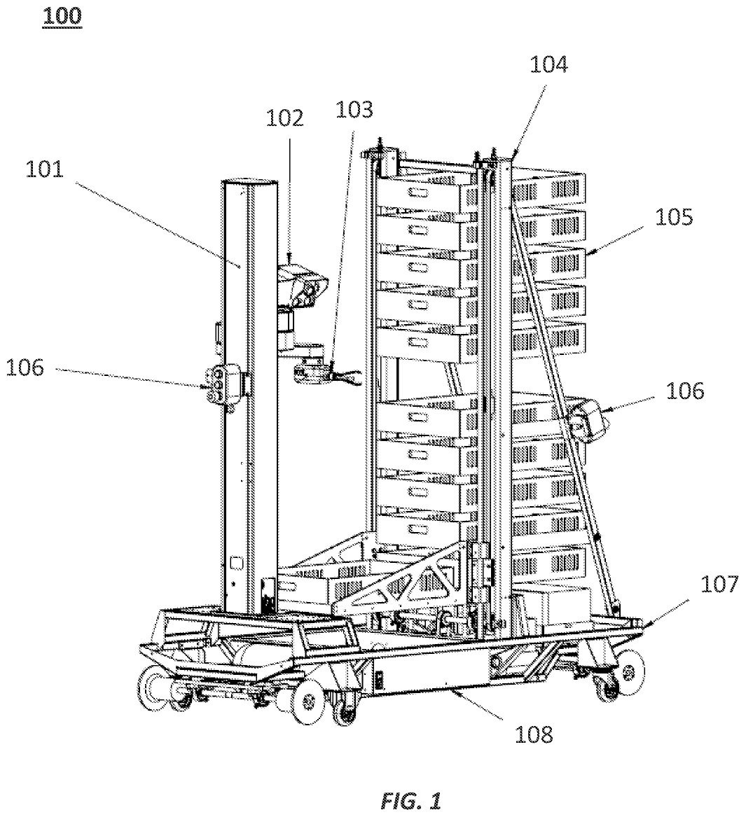

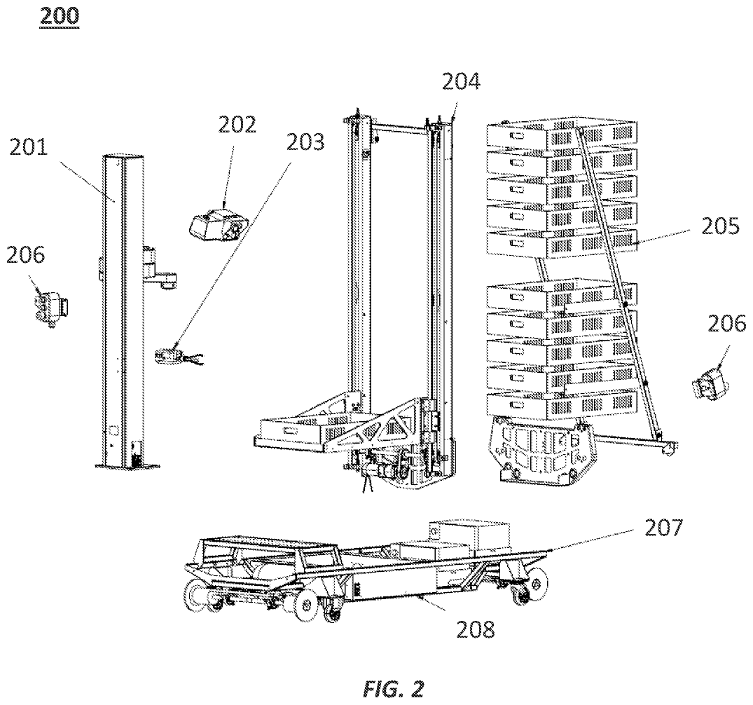

According to an embodiment as shown in FIGS. 1 and 2, a robotic agricultural product collection system 100, 200 may include a motorized mobility platform 107, 207 configured to be operable either on flat ground or compatible with equipment guides that may be conventionally found within protected cultivation greenhouses and tunnels. The mobility platform 107, 207 is generally configured to precisely control the location of the robotic agricultural product collection system 100, 200 along the length of a crop row.

With further reference to FIGS. 1 and 2, a robotic arm 101, 201 may be used to position a grasping tool 103, 203 in order to grasp agricultural products. Associated movement pathways for the arm manipulator may be strategically mapped and selected in order to avoid obstacles. The robotic arm 101, 201 may also be involved in the actuation of the grasping tool 103, 203. The grasping tool 103, 203, mounted to robotic arm 101, 201 and vertically adjustable along the height of the robotic arm 101, 201, is configured to grasp individual target objects of agricultural produce from plants and vines selectively and without damaging the target object, plant, or nearby items.

Agricultural product lift 104, 204 may be vertically adjustable using motors disposed in the mobility platform 107, 207 and can be positioned at selected vertical positions in order to accomplish a specific dropping height for harvested agricultural produce in a collection tray. A vertically arranged column of agricultural product trays or catches 105, 205 is associated with the product lift 104, 204. One or more product trays 105, 205 may be hosted in an active state on the lift at any given time during a harvesting operation in order to serve as a collection zone and may be interchanged with any number of empty agricultural product trays on demand when filled to a predetermined level. In this way, multiple trays of harvested agricultural produce may be accumulated on the platform. A vertically arranged column of full and empty trays may generally be positioned behind the active agricultural product tray.

An optical subsystem 102, 202 may be mounted to the robotic arm 101, 201 and can be vertically adjusted along the height of the robotic arm 101, 201. As discussed above and further below, the optical vision system 102, 202 may be involved in the identification of target objects for harvesting. The optical system 102, 202 may include components such as but not limited to a color imaging camera, a 3D depth imaging camera, a graphical processor, and a supplemental light source.

A controller 108, 208, disposed in the mobility platform 107, 207, coordinates the overall operating process described herein. Various computational subsystems control the different components highlighted above.

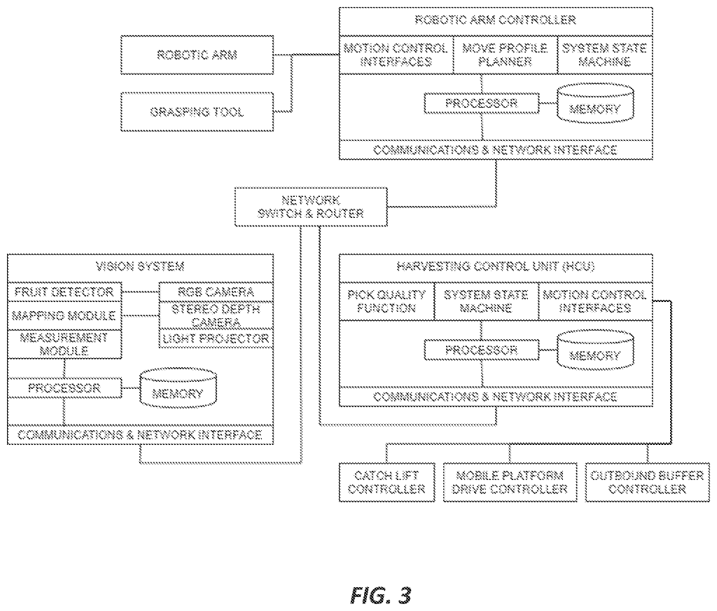

According to a process control embodiment shown in FIG. 3, the controller includes the overall state machine for system operation. In some aspects, the controller is configured to assess weighted factors and measurements determined by the optical system, e.g., to assign a quality to each potential target object of agricultural produce. In other aspects, the controller interfaces to motion controllers which actuate other components, such as the various motors of the mobility platform, the agricultural product lift, and the vertical arrangement of agricultural product trays.

In accordance with one or more embodiments, the optical vision subsystem contains an agricultural product detector module configured to determine the locations of agricultural product within a color image of a location, a mapping module configured to filter and rectify 3D point-cloud information collected by a stereo depth camera to convert agricultural product image locations to three-dimensional coordinates, and a measurement module configured to determine one or more characteristics of agricultural products, such as ripeness (proxied by color), size, and shape.

In accordance with one or more embodiments, the robotic arm subsystem contains a system state machine for controlling the functions of the articulating joints of the robotic arm, a movement planner that computes viable paths through space and converts them to desired articulating joint angles, velocities, and accelerations which may be executed to complete the path, and interfaces to motion controllers that actuate the articulating joints.

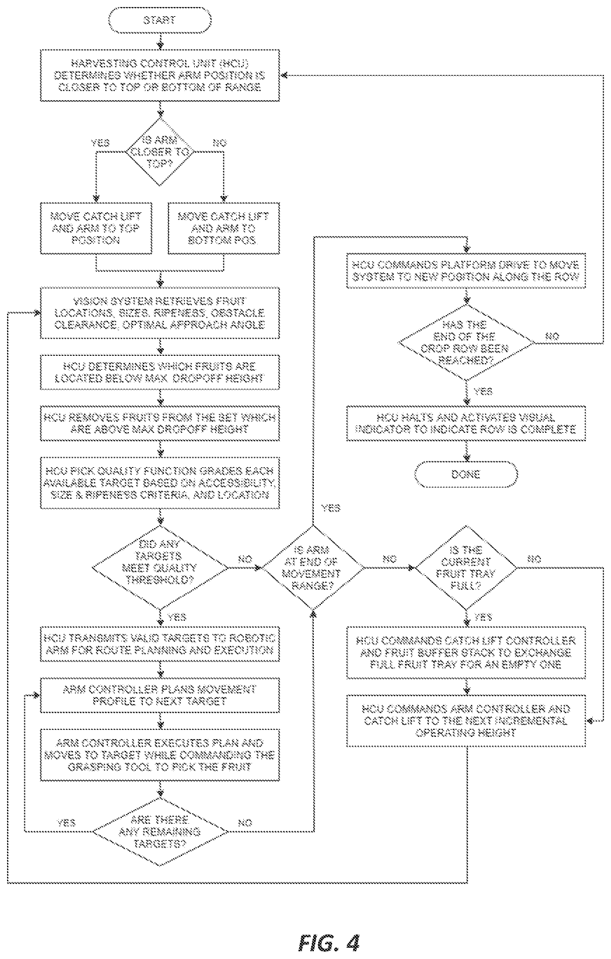

According to an embodiment shown in FIG. 4, the controller is configured to execute a program that is configured, in part, to collect agricultural products grown on a single side of a crop row, such as found in a Venlo-style greenhouse or the like. In this way, complete coverage harvesting may be achieved on one side of a crop row when executed to completion. A first operating height is implemented with respect to the robotic arm and catch lift. Agricultural products detected by the optical system having positions within the crop row that are greater than a maximum drop off height (selected by an operator or end user based on type or agricultural product, its maturity stage, i.e., ripeness, and mass to avoid damage to the agricultural product) are removed from the list of agricultural product to be collected. From the remaining agricultural products that are to be collected, the controller is configured to assesses the quality of the remaining agricultural products based on their compliance with specific threshold criteria for at least accessibility, size, ripeness, and shape. Accessibility may generally refer to the position of a target which is minimally obstructed by other nearby objects such that the target may be accessed without touching or moving other nearby objects or alternate targets. Obstacle clearance and/or optimal approach angle may generally relate to accessibility. Agricultural products that meet the specific threshold criteria are then passed onto the robotic arm controller for collection.

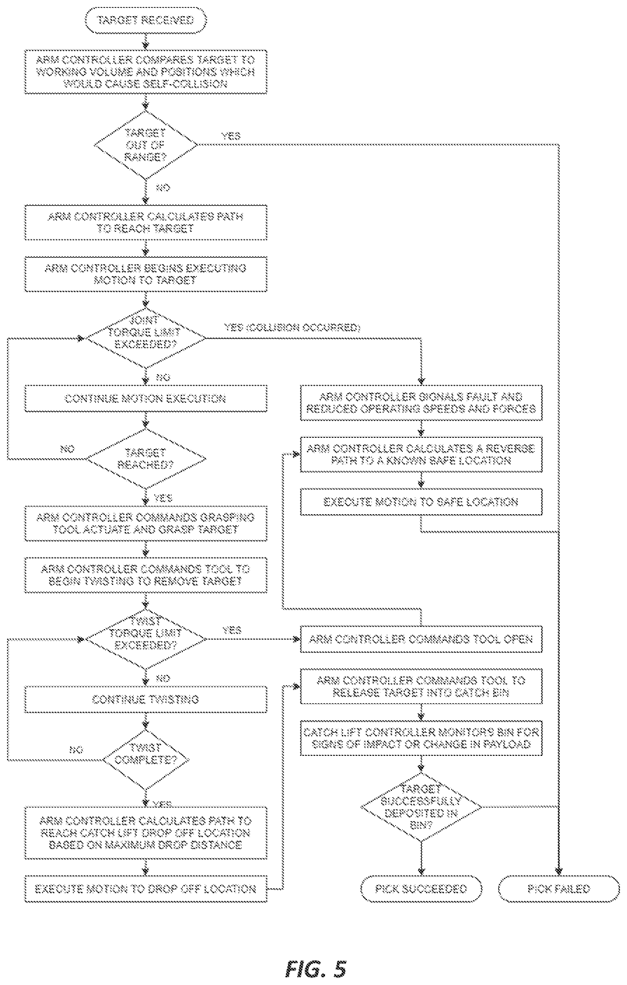

According to an embodiment shown in FIG. 5, the controller then executes a collection protocol until all of the target agricultural products are collected. After collection is completed, if the agricultural product tray is at its capacity, e.g., by exceeding a specific mass determined by the type of agricultural product collected, the full tray is exchanged with a new, empty agricultural product tray from the vertically arranged column of agricultural product trays disposed behind the active agricultural product tray.

FIG. 5 illustrates an embodiment of a harvesting cycle which includes a series of actions performed to pick a single target object. This harvesting cycle may generally be an expansion of the steps executed according to FIG. 4 with reference to the arm controller planning a movement profile and executing the planned movement profile.

The harvesting routine of FIG. 5. is executed primarily by the arm controller and includes key feedback components which may abort any individual pick attempt as failed with an identified cause (e.g. a collision occurred en-route, more torque was encountered while twisting the target object than expected, or the target was not successfully placed in the catch tray). Each mode of failure may be automatically recovered so that the process of FIG. 5 can continue. In the present embodiment and as depicted in FIG. 5, when an automatic recovery is required the robotic arm controller reduces its movement speed and acceleration considerably, calculates a movement path which travels the previously followed path which lead to collision or fault in reverse, and returns, under powered and position controlled motion, the arm and grasper to a retracted position which is known to typically be safe and free of collision hazards or other obstacles. Alternate embodiments of this automatic recovery procedure have been contemplated where one or more joints of the robotic arm or grasper would first be placed into a ‘limp’ unpowered and back drivable state before executing the computed reverse path to a safe location. In such a way, if the robotic arm or grasper has become entangled in objects within its environment, such as a vine or leaf, those ‘limp’ joints of the arm may be freely deflected by interaction with the tangling object during execution of the retraction movement, lessening the likelihood of a cyclically repeating collision fault and automatic recovery as the retraction move is executed.

The aforementioned steps of evaluating the agricultural products and collecting said agricultural products are repeated across a series of operating heights until one of two conditions is satisfied: the end of travel, e.g., the end of a crop row, is reached or no more satisfactory agricultural products remain. Under these conditions, the robotic agricultural product collection system is moved a configurable distance to a new lateral position in the crop row. The movement of the robotic agricultural product collection system is chosen to allow the working area of the optical system and robotic arm to partially overlap with that of the previous crop row location, thus ensuring that the maximum number of agricultural products may be accessed. If the end of the crop row has not been reached, the entire collection process as described herein is repeated.

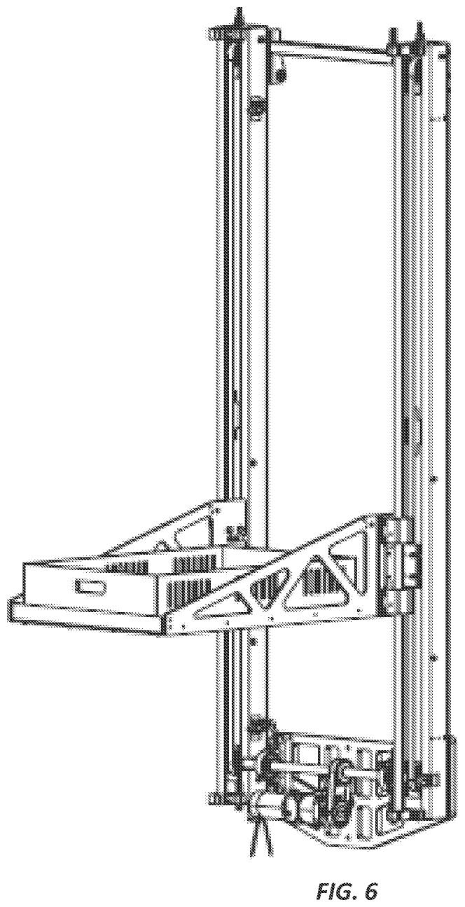

According to an embodiment shown in FIG. 6, a robotic agricultural product collection system as disclosed herein includes a vertical lifting system for agricultural product trays. The working stroke of the agricultural product tray lift is matched to the working height of the optical system and grasper tool on the robotic arm. This configuration ensures that the maximum drop height of a particular agricultural product that is set in the controller is limited to match the requirements of a given agricultural product or growing location, e.g., farm. The vertical lifting system includes an agricultural product tray platform that is connected to an actuation mechanism, such as a timing belt and linear recirculating ball bearing rails to guide the platform. In this specific embodiment, the timing belt is driven by a DC powered motor that is controlled to position using an encoder. In some embodiments, the DC motor may include a failsafe braking system configured to maintain the set vertical position of the agricultural product tray platform in the event of an interruption, such as a controller error or power loss. Alternative actuation methods for the vertical lifting system include, but are not limited to, rack and pinion, pistons, e.g., hydraulic or pneumatic cylinders, cables, roller chains, ball or lead screw. In some embodiments, linear guide rails may include, but are not limited to profile rails, rollers in channel or on round rails, or a monorail carriage on a structural section beam.

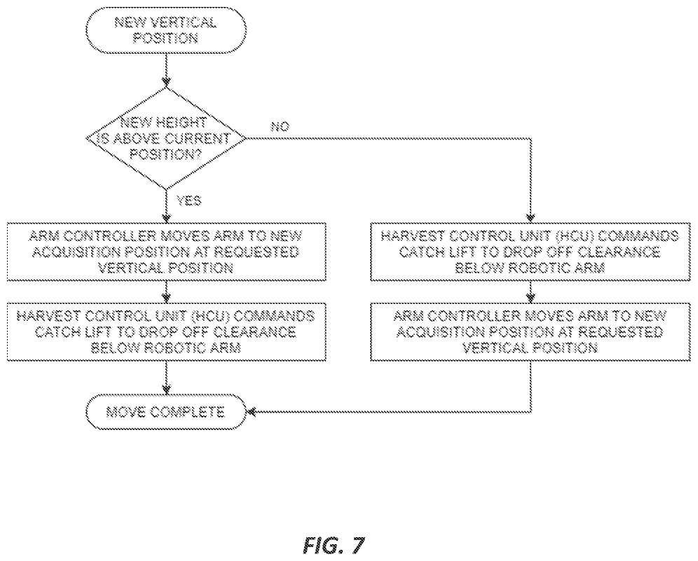

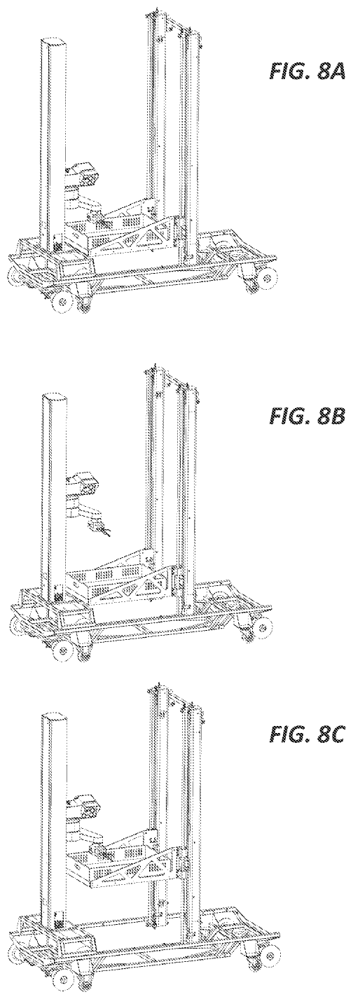

An embodiment of the control logic used to position and subsequently reposition the vertical platforming system for agricultural product trays of the robotic agricultural product collection system is shown in FIG. 7 and is pictorially shown in FIGS. 8A-8C. As shown in FIGS. 8A-8C, when the robotic arm and agricultural product tray platform are moved together to the next collection height, they are moved in a sequence that depends on the direction of motion to prevent collisions between the agricultural product tray platform and the robotic arm. For example, under normal operating conditions, the grasper tool of the robotic arm is physically above the agricultural product tray platform. In this configuration, to avoid a collision, the robotic arm moves up to the new vertical position first. Once the controller determines that adequate clearance has been created below the robotic arm and the agricultural product tray platform at the new collection height, the agricultural product tray platform is moved up to enforce the maximum agricultural product drop height as described herein.

In an alternate embodiment of the process depicted in FIG. 8A-8C, the harvesting controller, lift controller, and robotic arm controller may implement real-time feedback of position information for each moving element of the robotic arm or the agricultural product tray platform which enables continuous calculation of the current clearance distance between the two many times per second. In such an embodiment, the robotic agricultural product collection system may employ alternate control logic for moving these elements to the vertical work locations. Conventional closed-loop control methods, such as PID control, lag, or lead compensators, may be implemented and tuned in such a way that they use the real-time feedback of the robotic arm and agricultural product tray platform's instantaneous positions to dynamically adjust and maintain a constant clearance distance for release of harvested agricultural produce. In this way, the to systems move fluidly in continuous motion and always at the desired clearance distance from each other.

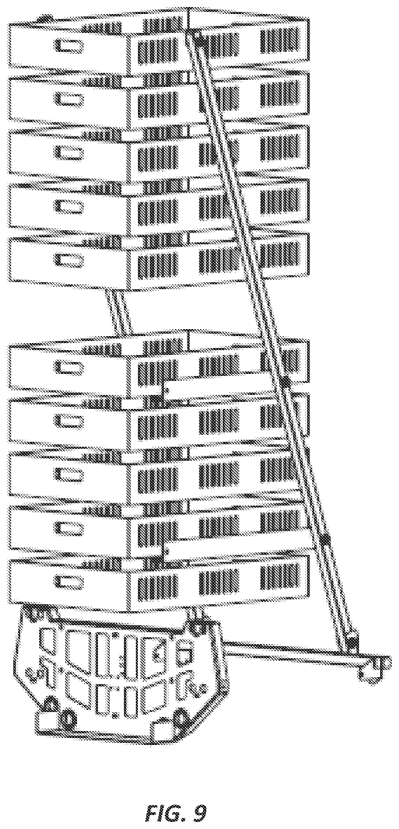

According to an embodiment shown in FIG. 9, a robotic agricultural product collection system as disclosed herein includes a vertical arrangement, e.g., column, of agricultural product trays adjacent to the agricultural product tray platform. The inclusion of empty agricultural product trays allows for the robotic agricultural product collection system to collect a plurality of agricultural products without requiring operator intervention. For example, the vertical column of agricultural product trays may allow for the robotic agricultural product collection system to operate for a span of time sufficient to collect agricultural products from a complete crop row in a greenhouse.

Once the agricultural product tray on the agricultural product tray platform is at capacity, e.g., by mass, the controller will instruct the agricultural product tray platform to move to a position that is not occupied by an agricultural product tray. The filled agricultural product tray is released by the agricultural product tray platform and is directed into an empty position in the vertical column of agricultural product trays by the robotic arm; this empty position is a buffer to ensure that a space is always present to receive a filled agricultural product tray so that an empty agricultural product tray can be cycled. The empty agricultural product tray platform can now be repositioned next to an empty agricultural product tray in the vertical column. Once the agricultural product tray platform is in position, the robotic arm retrieves an empty agricultural product tray and places it onto the agricultural product tray platform in an active state. The agricultural product tray platform may lock the agricultural product tray in position using various deployable mechanisms to ensure that it does not settle or break free while being transported vertically during collection.

In accordance with one or more embodiments, an agricultural product tray may be instrumented to facilitate overall process control and monitoring. In some embodiments, a tray may include a sensor such that delivery of a target object to the collection zone may be detected and/or verified. For example, the sensor may be a motion or impact sensor. In some embodiments, the sensor may aid in validating a predetermined drop distance so as to ensure that the target object does not get damaged when released into the collection tray. For example, the sensor can report impact forces exerted on a released target object and the drop distance defined by the spacing between the grasping tool and the collection tray may be modified accordingly if the detected impact force falls outside an acceptable range. The sensor may also be a weight sensor in order to help inform when it might be time to substitute an empty collection tray for a full collection tray. A target weight may be predetermined based on industry standards to facilitate delivery to the supply chain. In other embodiments, an impact sensor may be able to assist in counting or verifying the number of target objects delivered to the collection tray.

Such embodiments may employ sensors such as piezoelectric films, piezoelectric microphones, MEMS microphones, strain gauges, forces sensing resistors, or similar force transducers fixtured to the agricultural product tray or supporting lift structure in key locations which experience vibration or mechanical stresses when a piece of target agricultural produce impacts the tray. Using such a sensor, confirmation that a target piece of agricultural produce was caught by the tray may be accomplished using conventional signal processing techniques. First, the robotic arm controller sends an interrupt signal to the harvesting controller indicating that it is about to release a grasped target above the tray. Second, the harvesting controller may indicate via an interrupt signal to the lift controller that an impact is expected to occur within a configurable period of time after release. The lift controller, which interfaces with the sensor instrumentation on the agricultural product tray, may then rapidly read samples from the sensors in place many times per second (such as but not limited to a piezoelectric film based “contact microphone” or “vibration sensor”). Then, using conventional algorithms for peak finding or impact detection in acoustic signals, the lift controller may make a determination as to whether or not the released target object ultimately made contact with the tray. This result may then be reported to the harvesting controller. If the lift controller indicates to the harvesting controller that an impact occurred, the harvesting controller may then record that action as a successful drop off of the target produce item into the tray. Alternatively, if no impact occurred, it may record that action as a target which has been dropped on the floor or otherwise missed by the product tray.

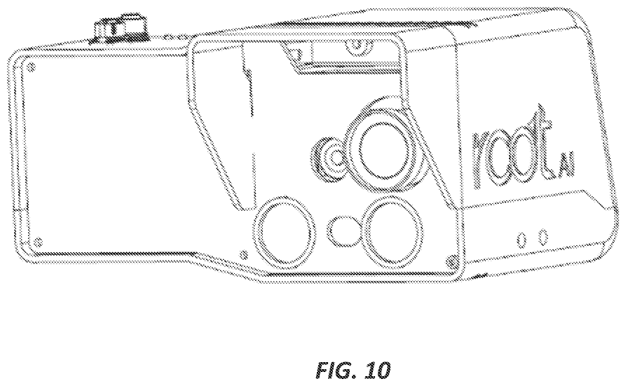

According to an embodiment shown in FIG. 10, a robotic agricultural product collection system as disclosed herein includes an optical system configured to identify agricultural products that are appropriate for collection and to send signals to the controller to direct the positions of the robotic arm and the agricultural product tray platform. In some embodiments, the optical system includes an RGB camera, a stereo vision camera, and a mobile compute module that includes programming for the selection of agricultural products. The optical system is configured to transmit representations of the position, orientation, and the measured ripeness levels of agricultural products in spatial coordinates to the controller housed in the mobility platform. The collected spatial coordinates of the agricultural products from the optical system may be used to instruct the robotic arm and grasping tool to collect the identified agricultural products. In this configuration, the optical system is configured to provide additional information to the robotic agricultural product collection system beyond the position and orientation of agricultural products to be collected. For example, the optical system may be configured to transmit information such as crop disease state, overall agricultural product health, estimated size, or weight of the target item, or pest infestation locations. This additional information may be used individually or in combination to determine the priority of selecting and retrieving certain target objects over others or for indicating to the system user than an issue requires their attention.

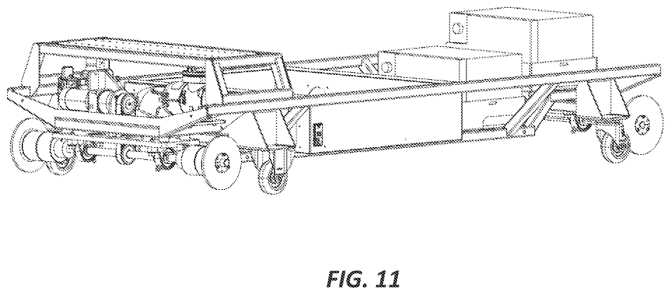

According to an embodiment shown in FIG. 11, a robotic agricultural product collection system as disclosed herein includes a mobility platform that is configured to include all necessary components of the robotic agricultural product collection system, e.g., robotic arm with grasper tool, agricultural product tray platform, and the controller, motors, and sources of electrical power. The mobility platform is also configured to allow the robotic agricultural product collection system to move within its environment, e.g., within a row of a greenhouse or similar enclosure. The mobility platform is configured as a modular base such that components may be interchanged to suit the various environments encountered in commercial agriculture settings. For example, in regularly ordered agricultural environments, such as greenhouses with well-defined rows, the mobility platform may be an autonomous guided vehicle (AGV) with 2D navigation facilities, e.g., including navigation along a single forward and reverse direction. As a non-limiting example, in a standard Venlo-style greenhouse, rows are arranged with pipe rails so that operators can access all the agricultural products on rail supported carts or lifts.

Additionally, the mobility platform of FIG. 11 may be configured with sensors positioned on one or both ends of the platform facing down the crop row in each direction. These sensors may be employed to detect when the mobile platform has traversed to the end of the row automatically by detecting changes in surrounding environment. These changes may include, but are not limited to, the absence of crops to the left and right, change in floor level, thresholds in the floor, terminating caps on pipe or floor rails, or purposefully installed placards or retro-reflectors positioned in such a way as to activate the sensor at a desired distance from the end of a row. The sensors used may include photoelectric, laser time-of-flight, metal induction, ultrasonic, mechanical limit switches, or other forms of proximity detection. In an alternate embodiment, sensors which produce spatial 2D or 3D data may instead be employed such as LIDAR scanners and color or monochromatic digital cameras. This data may instead be used to construct a map of the environment in which the robotic agricultural product collection platform operates or to measure the relative location of the platform in real time, providing accurate indication of the platform's exact location within a crop row in addition to its proximity to either end of the row. It should be appreciated that this embodiment may be preferred in some use cases, because it enables the harvesting controller to perform work on each area of the crop row multiple times based on selected criteria. For example, the actions of FIG. 4 may be performed multiple times on each location of the crop row to ensure that multiple attempts to harvest any erroneously disregarded items are made and that the highest possible percentage of agricultural produce has been harvested overall.

The mobility platform may be configured to include the controller for the robotic agricultural product collection system. As described herein, the controller includes power distribution and computation that coordinates the operation of all the individual components of the system, e.g., the robotic arm, optical system, and the agricultural product tray platform. The mobility platform may be configured to include the sources of electrical power, such as batteries.

In some embodiments, the mobility platform includes a battery charger that is configured to be electrically connected to a standard electrical receptacle, i.e., 110/120V or 210/220/240 V. The mobility platform may further include a source of compressed air, such as a compressed gas cylinder or an on-board air compressor, that is configured to provide air pressure for operating one or more components of the agricultural product collection system. For example, the source of compressed air may be configured to operate the grasping tool. The mobility platform is configured to allow the agricultural product collection system to move within a particular location, such as a row in a greenhouse or the like. In some embodiments, the mobility platform may include wheels or casters that allow movement of the system. In a non-limiting example, the mobility platform may include rail wheels that interface with the crop row rails of a greenhouse and an electric motor to drive the rail wheels over the rails. In another non-limiting example, the mobility platform may include, alternatively or in addition, casters that allow for the movement of the system when disengaged from the rails of a greenhouse, such as movement over the concrete causeway of a farm or a similar location. Casters or similar structures may or may not include a motor to drive them.

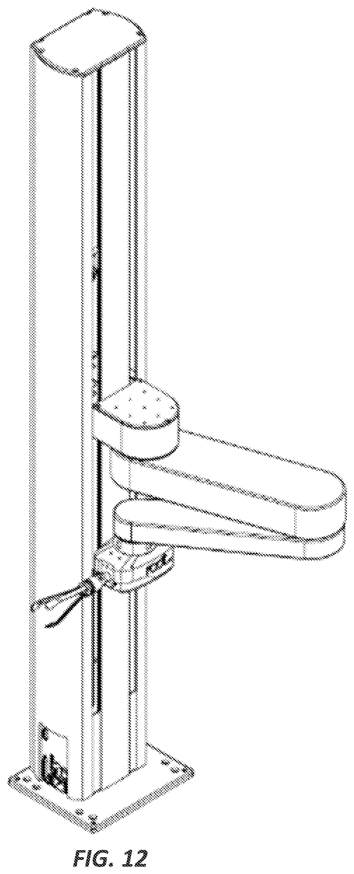

According to an embodiment shown in FIG. 12, a robotic agricultural product collection system as disclosed herein includes a robotic arm including a grasper tool at its terminal end. The robotic arm and end of arm tool are a multiple degree of freedom (4+) free space manipulation system with a tunably compliant grasping tool designed to navigate to target objects and remove them from the growing environment. A work area matching as closely as possible to the growing area is required, and so a long vertical axis (>1 m) is preferred. This configuration allows for the maximal coverage of the environment by the manipulator's work area envelope. The arm is positioned on a pedestal base which can be reconfigured to perfectly align the robot to the crop row configuration of any given farm. The grasping tool's fingers are designed to be interchangeable to enable harvesting of variously sized target objects without significant system downtime and to reduce risk of spreading farm pests and infections.

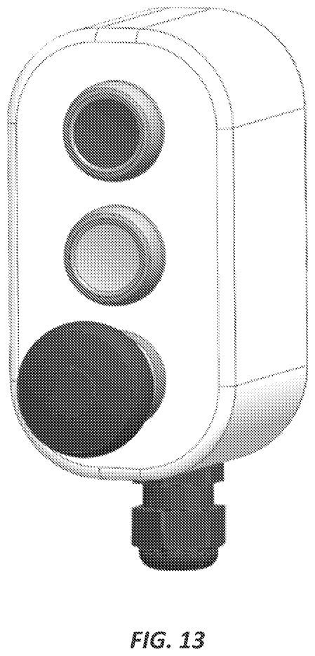

In accordance with one or more embodiments, during normal operation, the systems and methods may be designed to be operated by a single user with no auxiliary interface devices such as computers, tablets or mobile phones. To make user input robust to the harsh environments of agricultural cultivation, physical pushbuttons may be employed to convey user input to the controller. FIG. 13 depicts an embodiment of an arrangement of backlit buttons and a large mushroom style ‘Emergency-Stop’ button. Using this arrangement of user interface elements, placed on both the front and rear of the robot's frame, the user may control the robotic harvesting system in some non-limiting embodiments. For example, this three-button interface can be used to reset fault conditions, start or continue harvesting operation, stop or pause harvesting operation, or immediately stop motion in a safety related situation. When the backlights of the buttons display certain colors, animations or temporal patterns, the user may be prompted to provide various commands. For instance, a red pulsing pattern of status light could indicate low battery state and inform the user to connect the platform to an outlet and begin the charging sequence.

In accordance with one or more embodiments, the robotic harvesting system may autonomously move forward and backward linearly along a crop row. The system may advance automatically along a row as described herein when all target objects in its vertical work area have been harvested. When one side of one row has been completely harvested, the user may be required to restart operation on crops that still bear target objects. To restart harvesting the user may, for example, first make sure that all of the collection trays in the buffer have been emptied or replaced. Next the user may rotate the robotic harvesting system 180° and return it to an opposite side of the same row, so that the robot can harvest the opposite side of the row. When commanded to commence harvesting, the robotic system may begin to harvest in the travel direction opposite to the location of the button used to send the command. Upon completion of the opposite side of the row, the robotic harvesting system may return to the user's end of the crop row and indicate required user intervention. Finally, when both sides of a row are harvested, the robotic harvesting system may be rotated back 180° and placed at the head of the next row to harvest. In some embodiments, the robotic system may be configured to execute 180° rotation autonomously. In other embodiments, a user may rotate the system as described herein. FIGS. 14A-C illustrate a non-limiting scheme for robotically harvesting both sides of multiple rows of agricultural produce in accordance with various embodiments. As depicted, the robotic system may move automatically along a first row, a user may turn the robotic system to harvest the opposite side of the first row, and then the user may reposition the robotic system at a second row for harvesting.

It is to be understood that the disclosed subject matter is not limited in its application to the details of construction and to the arrangements of the components set forth in this description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A robotic harvesting system, comprising:
a mobile platform;
a manipulator arm mounted on the mobile platform and including a gripper tool;
a collection tray; and
a controller configured to:
position the mobile platform at a first lateral position along a first row of crops;
position the manipulator arm at a first operational height, the first lateral position and the first operational height defining a first working area;
survey the first working area to identify target objects of agricultural produce for harvesting; and
actuate the gripper tool in response to identifying target objects of agricultural produce within the first working area to harvest them.

2. The system of claim 1, wherein the controller is further configured to position the manipulator arm at second and subsequent operational heights.

3. The system of claim 2, wherein the controller is further configured to position the mobile platform at second and subsequent lateral positions along the first row of crops.

4. The system of claim 3, wherein the controller is further configured to reposition the mobile platform at the first lateral position after the second lateral position along the first row of crops.

5. The system of claim 1, further comprising a vision system in cooperation with the controller to identify the target objects of agricultural produce within the first working area.

6. The system of claim 5, wherein the vision system comprises one or more of: a color imaging camera, a 3-D depth imaging camera, a graphical processor, and a supplemental light source.

7. The system of claim 1, wherein the mobile platform is compatible with equipment guide rails.

8. The system of claim 1, further comprising a tray lift in communication with the controller and configured to position the collection tray at a predetermined drop height relative to the gripper tool at each operational height.

9. The system of claim 8, wherein the controller is further configured to operate the tray lift and the manipulator arm in unison across operational heights to maintain the predetermined drop height.

10. The system of claim 1, further comprising a plurality of interchangeable collection trays in association with the tray lift, wherein the controller is further configured to periodically replace the collection tray.

11. The system of claim 1, wherein the collection tray comprises a sensor and wherein the controller is further configured to validate delivery of target objects to the collection tray based on input from the sensor.

12. The system of claim 1, wherein the target object of agricultural produce comprises a tomato, a cucumber, a pepper or a strawberry.

13. A method of harvesting agricultural produce, comprising: use of the robotic harvesting system of any of claims 1-12.

14. The method of claim 13, further comprising repositioning the robotic harvesting system at a second side of the first row of crops.

15. The method of claim 14, further comprising repositioning the robotic harvesting system at a first side of a second row of crops.

16. The method of claim 13, further comprising preselecting at least one parameter for the identification of target objects within the working area.

17. The method of claim 16, wherein the at least one parameter pertains to color, size, shape, obstacle clearance, and/or distance which must be traversed to retrieve the target object.

18. The method of claim 13, further comprising establishing a priority for retrieval of identified target objects based on at least one property of the target object of agricultural produce.

19. The method of claim 13, further comprising establishing the predetermined drop height based on at least one property of the target object of agricultural produce.

20. The method of claim 13, further comprising establishing the various lateral positions and associated operational heights.

21. The method of claim 13, further comprising delivering a collection tray to a downstream supply chain.

22. The method of claim 13, further comprising premature cessation of delivering a target object to the collection tray in response to detecting collision with the environment while en route.

23. The method of claim 13, further comprising premature cessation of delivering a target object to the collection tray in response to detecting entanglement with items in the environment such that the target object cannot be extricated from the plant.

24. The method of claim 13, further comprising a method of automatically resuming collection or delivery of a target object after a premature cessation of delivering the current or previous target object has occurred.
